(19) United States
(12) Patent Application Publication
(10) Pub. No.: US 2025/0048383 A1
(43) Pub. Date: Feb. 6, 2025

(54) METHOD, DEVICE AND COMPUTER STORAGE MEDIUM OF COMMUNICATION

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 18/720,289

(22) PCT Filed: Dec. 15, 2021
(86) PCT No.: PCT/CN2021/138490

§ 371 Date: Jun. 14, 2024

(51) Int. Cl. H04W 72/231; H04W 76/38; H04W 76/40

(52) U.S. Cl. CPC H04W 72/231; H04W 76/38; H04W 76/40

(57) ABSTRACT

Embodiments of the present disclosure relate to methods, devices and computer readable media for communication. A first device receives, from a second device serving the first device, a RRC reconfiguration message and determines whether the RRC reconfiguration message comprises information on a path switch to a third device. The first device is to be communicated with a fourth device serving the third device via the third device and the first device is to be communicated with the third device via a sidelink interface. If the RRC reconfiguration message comprises the information, the first device determines a configuration of the first device for the path switch based on a type of the path switch. In this way, a procedure for a path switch to relay UE may be provided.

### TECHNICAL FIELD

Embodiments of the present disclosure generally relate to the field of telecommunication, and in particular, to methods, devices and computer storage media of communication for sidelink relay.

### BACKGROUND

In context of new radio (NR) sidelink relay, user equipment (UE) that is communicated with a gNB via another UE in coverage (IC) of the gNB is called as remote UE, and the other UE is called as a relay UE. The remote UE may be out of coverage (OoC) of the gNB, and also may be in coverage of the gNB. A connection is established between the remote UE and the relay UE via a sidelink.

In study of sidelink relay, there is a need to specify mechanisms for service continuity which include a direct to indirect path switch or an indirect to indirect path switch. A direct path means there is no relay UE between a remote UE and a gNB and an indirect path means there is a relay UE between a remote UE and a gNB. For the direct to indirect path switch or the indirect to indirect path switch, implementation for the path switch is incomplete and to be further developed.

### SUMMARY

In general, embodiments of the present disclosure provide methods, devices and computer storage media of communication for a path switch in sidelink relay.

In a first aspect, there is provided a method of communication. The method comprises: receiving, at a first device and from a second device serving the first device, a radio resource control (RRC) reconfiguration message; determining whether the RRC reconfiguration message comprises information on a path switch to a third device, wherein the first device is to be communicated with a fourth device serving the third device via the third device and the first device is to be communicated with the third device via a sidelink interface; and in accordance with a determination that the RRC reconfiguration message comprises the information, determining a configuration of the first device for the path switch based on a type of the path switch.

In a second aspect, there is provided a method of communication. The method comprises: transmitting, at a second device and to a first device served by the second device, a RRC reconfiguration message comprising information on a path switch to a third device, wherein the first device is to be communicated with a fourth device serving the third device via the third device and the first device is to be communicated with the third device via a sidelink interface.

In a third aspect, there is provided a method of communication. The method comprises: receiving, at a third device, a RRC reconfiguration complete message from a first device; forwarding the RRC reconfiguration complete message to a fourth device, wherein the first device is to be communicated with the fourth device via the third device and the first device is to be communicated with the third device via a sidelink interface; and transmitting, to the first device, a fourth indication regarding the RRC reconfiguration complete message.

In a fourth aspect, there is provided a device of communication. The device comprises a processor configured to perform the method according to the first or third aspect of the present disclosure.

In a fifth aspect, there is provided a device of communication. The device comprises a processor configured to perform the method according to the second of the present disclosure.

In a sixth aspect, there is provided a computer readable medium having instructions stored thereon. The instructions, when executed on at least one processor, cause the at least one processor to perform the method according to the first or third aspect of the present disclosure.

In a seventh aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure may be implemented;

FIG. 1B illustrates a schematic diagram of a user plane protocol stack in which some embodiments of the present disclosure can be implemented;

FIG. 1C illustrates a schematic diagram of a control plane protocol stack in which some embodiments of the present disclosure can be implemented;

FIG. 1D illustrates a schematic diagram of a control plane protocol stack for a sidelink control channel (SCCH) for PC5-radio resource control (PC5-RRC) in which some embodiments of the present disclosure can be implemented;

FIG. 1E illustrates a schematic diagram of a control plane protocol stack for SCCH for PC5-signaling (PC5-S) in which some embodiments of the present disclosure can be implemented;

FIG. 2 illustrates a schematic diagram illustrating a process of communication for a path switch according to embodiments of the present disclosure;

FIG. 3 illustrates a flowchart for an example method of communication implemented at a first device in accordance with some embodiments of the present disclosure;

FIG. 4 illustrates a flowchart for an example method of communication implemented at a second device in accordance with some embodiments of the present disclosure;

FIG. 5 illustrates a flowchart for an example method of communication implemented at a third device in accordance with some embodiments of the present disclosure; and

FIG. 6 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present application, the term “remote UE” refers to a terminal device that is communicated with a network device via another terminal device in coverage of the network device. The term “relay UE” refers to a terminal device that is in coverage of a network device and via which remote UE is communication with the network device. The relay UE is connected with the remote UE via a sidelink interface such as a PC5 interface or the like. The term “remote UE” can be used interchangeably with a remote terminal device or a remote device. The term “relay UE” can be used interchangeably with a relay terminal device or a relay device.

For service continuity, in some scenarios, remote UE may be switched from communicating with the gNB directly to communicating with gNB indirectly via relay UE. This is called as a direct to indirect path switch. In some scenarios, remote UE may be switched from communicating with gNB indirectly via relay UE to communicating with the gNB indirectly via another relay UE. This is called as an indirect to indirect path switch. For these scenarios, a path switch to a relay UE needs to be implemented.

Embodiments of the present disclosure provide a solution for starting a path switch to relay UE. In the solution, in response to receiving a RRC reconfiguration message from gNB, remote UE determines whether the RRC reconfiguration message comprises information on a path switch to relay UE. If the RRC reconfiguration message comprises the information on the path switch to relay UE, the remote UE starts a timer configured for the path switch. In this way, a path switch to relay UE may be identified and started.

Principles and implementations of the present disclosure will be described in detail below with reference to the figures.

### Example of Communication Network

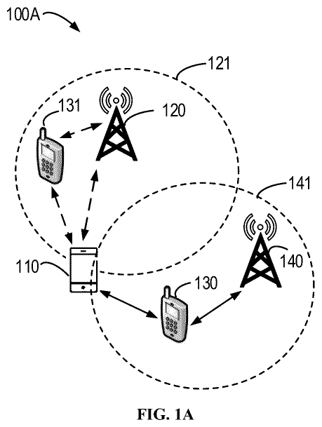

FIG. 1 illustrates a schematic diagram of an example communication network 100 in which some embodiments of the present disclosure can be implemented. As shown in FIG. 1, the communication network 100 may include a first device 110, a second device 120, a third device 130, a further third device 131 and a fourth device 140. The second device 120 provides a cell 121 to serve one or more devices and the fourth device 140 provides a cell 141 to serve one or more devices. In the example of FIG. 1, the third device 130 is located within the cell 141 of the fourth device 140, and may directly communicate with the fourth device 140. The further third device 131 is located within the cell 121 of the second device 120, and may directly communicate with the second device 120.

In some cases, the first device 110 may directly communicate with the second device 120 when the first device 110 is located within the cell 121. The first device 110 may communicate with the second device 120 via the further third device 131 when the first device 110 is located outside or within the cell 121. Similarly, the first device 110 may also directly communicate with the fourth device 140 when the first device 110 is located within the cell 141. The first device 110 may communicate with the fourth device 140 via the third device 130 when the first device 110 is located outside or within the cell 141. In these cases, the first device 110 may correspond to remote UE, and the third device 130 or the further third device 131 may correspond to relay UE.

In some embodiments, the first device 110 and the second device 120 may communicate with each other via a channel such as a wireless communication channel. The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible. In similar way, the first device 110 and the fourth device 140 may also communicate with each other.

In some embodiments, the first device 110 and the third device 130 may communicate with each other via a sidelink channel such as a physical sidelink shared channel (PSSCH), a physical sidelink control channel (PSCCH), a physical sidelink feedback channel (PSFCH), a physical sidelink broadcast channel (PSBCH) or the like. For example, a PC5 link or PC5 RRC connection may be established between the first device 110 and the third device 130. In similar way, the first device 110 and the further third device 131 may also communicate with each other.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

It is to be understood that the number of devices in FIG. 1 is given for the purpose of illustration without suggesting any limitations to the present disclosure. The communication network 100 may include any suitable number of first devices, second devices, third devices or fourth devices adapted for implementing implementations of the present disclosure.

For illustration, the first device 110, the third device 130 and the further third device 131 are shown as terminal devices and the second device 120 and the fourth device 140 are shown as a network device. Merely for illustration purpose and without suggesting any limitations as to the scope of the present disclosure, some embodiments will be described in the context where the first device 110, the third device 130 and the further third device 131 are terminal devices and the second device 120 and the fourth device 140 are network devices.

It is to be understood that, in other embodiments, the first device 110 and/or the third device 130 and/or the further third device 131 may be a network device and the second device 120 and/or the fourth device 140 may be a terminal device. In other words, the principles and spirits of the present disclosure can be applied to both uplink and downlink transmissions. Further, in some embodiments, all of the first device 110, the second device 120, the third device 130, the further third device 131 and the fourth device 140 may be terminal devices, and in some embodiments, all of the first device 110, the second device 120, the third device 130, the further third device 131 and the fourth device 140 may be network devices. The present application does not limit this aspect.

The communications between a terminal device and a network device in communication network 100 may be performed in accordance with user plane and control plane protocol stacks. Generally speaking, for a communication device (such as a terminal device or a network device), there are a plurality of entities for a plurality of network protocol layers in a protocol stack, which can be configured to implement corresponding processing on data or signaling transmitted from the communication device and received by the communication device. FIG. 1B illustrates a schematic diagram 100B illustrating network protocol layer entities that may be established for user plane protocol stack at devices according to some embodiments of the present disclosure. For illustration, the following description is given by taking the first device 110 as an example of the terminal device and taking the second device 120 as an example of the network device.

As shown in FIG. 1B, in the user plane, each of the first device 110 and the second device 120 may comprise an entity for the L1 layer, i.e., an entity for a physical (PHY) layer (also referred to as a PHY entity), and one or more entities for upper layers (L2 and L3 layers, or upper layers) including an entity for a media access control (MAC) layer (also referred to as a MAC entity), an entity for a RLC layer (also referred to as a RLC entity), an entity for a packet data convergence protocol (PDCP) layer (also referred to as a PDCP entity), and an entity for a service data application protocol (SDAP) layer (also referred to as a SDAP entity, which is established in 5G and higher-generation networks). In some cases, the PHY, MAC, RLC, PDCP, SDAP entities are in a stack structure.

FIG. 1C illustrates a schematic diagram 100C illustrating network protocol layer entities that may be established for control plane protocol stack at devices according to some embodiments of the present disclosure. As shown in FIG. 1C, in the control plane, each of the first device 110 and the second device 120 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a RRC layer (also referred to as a RRC entity). The RRC layer may be also referred to as an access stratum (AS) layer, and thus the RRC entity may be also referred to as an AS entity. As shown in FIG. 1C, the first device 110 may also comprise an entity for a non-access stratum (NAS) layer (also referred to as a NAS entity). An NAS layer at the network side is not located in a network device and is located in a core network (CN, not shown). In some cases, these entities are in a stack structure.

Generally, channels between the RRC layer and PDCP layer are called as radio bearers. A terminal device (for example, the first device 110 or the third device 130) may be configured with at least one data radio bearer (DRB) for bearing data plane data and at least one signaling radio bearer (SRB) for bearing control plane data. The RRC layer may be used interchangeably with Uu RRC layer, RRC entity, Uu RRC entity.

The communications between terminal devices in the communication network 100 may be performed in accordance with control plane protocol stacks. FIG. 1D illustrates a schematic diagram 100D of a control plane protocol stack for a SCCH for PC5-RRC in which some embodiments of the present disclosure can be implemented. For illustration, the following description is given by taking the first device 110 and the third device 130 as examples of the terminal devices.

As shown in FIG. 1D, in the control plane, each of the first device 110 and the third device 130 may comprise an entity for the L1 layer, i.e., an entity for a PHY layer (also referred to as a PHY entity), and one or more entities for upper layers (L2 and L3 layers, or upper layers) including an entity for a MAC layer (also referred to as a MAC entity), an entity for a RLC layer (also referred to as a RLC entity), an entity for a PDCP layer (also referred to as a PDCP entity), and an entity for a PC5-RRC layer (also referred to as a PC5-RRC entity). In some cases, the PHY, MAC, RLC, PDCP, PC5-RRC entities are in a stack structure.

In some embodiments, the RRC entity and the PC5-RRC entity may be the same entity (e.g. logical entity). Of course, the RRC entity and the PC5-RRC entity may be different entities (e.g. logical entities). In some embodiments, the RRC layer and the PC5-RRC layer may be realized as the same layer. Of course, the RRC layer and the PC5-RRC layer may be realized as different layers.

FIG. 1E illustrates a schematic diagram 100E illustrating a control plane protocol stack for SCCH for PC5-S in which some embodiments of the present disclosure can be implemented. As shown in FIG. 1E, in the control plane, each of the first device 110 and the third device 130 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a PC5-S layer (also referred to as a PC5-S entity). In some cases, the PHY, MAC, RLC, PDCP, PC5-S entities are in a stack structure.

Generally, the PC5-RRC layer may manage a PC5 RRC connection (e.g. to establish/modify/release sidelink DRBs, to (re-)configure NR sidelink measurement and reporting, to (re-)configure sidelink CSI reference signal resources and CSI reporting latency bound) and the PC5-S layer may manage a PC5 unicast link. In the context of the present disclosure, the PC5 RRC connection may be used interchangeably with a PC5 connection. The PC5 unicast link may be used interchangeably with a PC5 link, Layer-2 link over PC5, PC5 Layer-2 link, Layer-2 link or layer-2 link. The PC5-RRC layer may be used interchangeably with a PC5 RRC entity, PC5 RRC, PC5 RRC layer, PC5-RRC, AS layer, or the lower layer of PC5-S layer. The PC5-S layer may be used interchangeably with a PC5 signaling layer, PC5 signaling sublayer, V2X layer, the upper layer of PC5-RRC layer, the upper layer of RRC layer, or NAS layer. The RRC layer may be used interchangeably with a Uu RRC layer, RRC entity or AS layer. The RRC layer may be used interchangeably with the lower layer of PC5-S layer.

Return to FIG. 1A, in some scenarios, the first device 110 may be directly communicated with the second device 120 or may be communicated with the second device 120 via the further third device 131 in an earlier stage. As the first device 110 moves, the first device 110 may need to perform a path switch so as to be communicated with the fourth device 140 via the third device 130. It is to be understood that the second device 120 and the fourth device 140 may be the same one device. Of course, the second device 120 and the fourth device 140 may also be different devices.

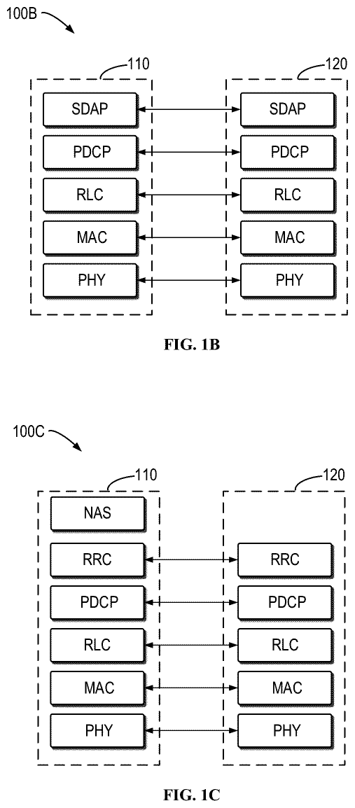

Embodiments of the present disclosure provide a solution for starting the path switch for these scenarios. The detailed description will be made below with reference to FIG. 2.

### Example Implementation of Path Switch

FIG. 2 illustrates a schematic diagram illustrating a process 200 of communication for a path switch according to embodiments of the present disclosure. For the purpose of discussion, the process 200 will be described with reference to FIG. 1. The process 200 may involve the first device 110, the second device 120, the third device 130 and the fourth device 140 as illustrated in FIG. 1. The steps and the order of the steps in FIG. 2 are merely for illustration, and not for limitation. For example, the order of the steps may be changed. Some of the steps may be omitted or any other suitable additional steps may be added. In this example, the fourth device 140 serves the third device 130 and the second device 120 serves the first device 110. The first device 110 is to be switched to be communicated with the fourth device 140 via the third device 130, and the first device 110 is to be communicated with the third device 130 via a sidelink interface.

As shown in FIG. 2, the second device 120 may transmit 201 a RRC reconfiguration message to the first device 110. In some embodiments, when the second device 120 decides to perform a handover procedure or a path switch for the first device 110, the second device 120 may transmit the RRC reconfiguration message. For example, when the second device 120 decides to perform an indirect to indirect path switch from communication of the first device 110 via the further third device 131 to communication of the first device 110 via the third device 130, the second device 120 may transmit the RRC reconfiguration message to the first device 110. As another example, when the second device 120 decides to perform a direct to indirect path switch from direct communication of the first device 110 to communication of the first device 110 via the third device 130, the second device 120 may transmit the RRC reconfiguration message to the first device 110. As still another example, when the second device 120 decides to perform a handover from direct communication of the first device 110 with the second device 120 to direct communication of the first device 110 with the fourth device 140, the second device 120 may transmit the RRC reconfiguration message to the first device 110.

It is to be understood that the RRC reconfiguration message may be any suitable messages for RRC reconfiguration. For example, the RRC reconfiguration message may be PC5-S signaling, PC5-RRC signaling or the like.

Upon reception of the RRC reconfiguration message, the first device 110 determines 202 whether the RRC reconfiguration message comprises information on a path switch to the third device 130. In other words, the first device 110 determines whether the RRC reconfiguration message indicates a path switch to relay UE. For example, the first device 110 may determine whether ReconfigurationWithSync in the RRC reconfiguration message comprises the information on the path switch. It is to be understood that the information on the path switch may also be carried in any other suitable ways.

In some embodiments, the information may comprise an identity (ID) of the third device 130. Based on the identity of the third device 130, the first device 110 may know that the path switch to be performed is a path switch to relay UE.

In some embodiments, the information may comprise an ID of the fourth device 140. Based on the identity of the fourth device 140, the first device 110 may determine whether the path switch is an intra-gNB or inter-gNB path switch.

In some embodiments, the information may comprise a configuration of a timer for the path switch. In other words, the timer is used for a direct to indirect path switch or an indirect to indirect path switch. That is, the timer is used for the path switch to relay UE, rather than to a network device. Thus the timer may be different from existing timer T304 that is used for a path switch to a network device. Based on the configuration, the first device 110 may start the timer to determine whether the path switch is performed successfully. For example, if the timer expires, the first device 110 may determine that the path switch is not performed successfully and may initiate a RRC reestablishment.

In some embodiments, the information may comprise an indication (for convenience, also referred to as a first indication herein) indicating a direct to indirect path switch or an indirect to indirect path switch. In other words, the first indication indicates the path switch to relay UE, regardless of a direct to indirect path switch or an indirect to indirect path switch.

In some embodiments, the information may comprise an indication (for convenience, also referred to as a second indication herein) indicating a direct to indirect path switch. In some embodiments, the information may comprise an indication (for convenience, also referred to as a third indication herein) indicating an indirect to indirect path switch. In this way, the first device 110 may know a type of the path switch to be performed.

Upon determination that the RRC reconfiguration message comprises the information on the path switch to the third device 130, the first device 110 determines 203 a configuration of the first device 110 for the path switch. In some embodiments, if the RRC reconfiguration message does not comprise the information on the path switch to the third device 130, for example, if the RRC reconfiguration message comprises information on a handover to another network device, the first device 110 may determine a configuration of the first device 110 for the handover. The present disclosure does not limit the configuration for the handover, but is intended to provide a solution for determining the configuration for the path switch.

In some embodiments, the first device 110 may determine the configuration of the path switch based on a type of the path switch. The type of the path switch may comprise a direct to indirect path switch or an indirect to indirect path switch. In some embodiments, the first device 110 may determine the type of the path switch based on an explicit indication of the type of the path switch. For example, the explicit indication may be comprised in the information on the path switch. In some embodiments, the first device 110 may determine the type of the path switch in an implicit way based on an identity of the fourth device 140 and an identity of the second device 120 indication.

In some embodiments, the first device 110 may determine the configuration of the first device 110 for the path switch at least based on an ID of the fourth device 140 and an ID of the second device 120. In some embodiments, the ID of the fourth device 140 may comprise an ID of a gNB provided by the fourth device 140. In some embodiments, the ID of the fourth device 140 may comprise an ID of a cell group provided by the fourth device 140. In some embodiments, the ID of the fourth device 140 may comprise an ID of a special cell (SpCell) provided by the fourth device 140. In some embodiments, the ID of the second device 120 may comprise an ID of a gNB provided by the second device 120. For example, the gNB ID may be an integer with 22 bits or 32 bits. In some embodiments, the ID of the second device 120 may comprise an ID of a cell group provided by the second device 120. For example, the cell group ID may be an integer. In some embodiments, the ID of the second device 120 may comprise an ID of a SpCell provided by the second device 120. For example, the SpCell ID may be a physical cell ID (PCI), a NR cell identifier (NCI), a NR cell global identifier (NCGI), or a serving cell index. As another example, the SpCell ID may be an integer. Of course, any other suitable forms are also feasible for the SpCell ID.

In some embodiments, if the ID of the fourth device 140 comprise an ID of a gNB and the second device 120 comprise an ID of a gNB, it is referred to as an inter-gNB path switch if the two IDs of gNBs are different and it is referred to as an intra-gNB path switch if the two IDs of gNBs are the same. In some embodiments, if the ID of the fourth device 140 comprise an ID of a cell group and the second device 120 comprise an ID of a cell group, it is referred as an inter-CellGroup path switch if the two IDs of cell groups are different; it is referred as an intra-CellGroup path switch if the two IDs of cell groups are different. In some embodiments, if the ID of the fourth device 140 comprise an ID of a SpCell and the second device 120 comprise an ID of a SpCell, it is referred as an inter-SpCell path switch if the two IDs of SpCells are different; it is referred as intra-SpCell path switch if the two IDs of SpCells are different. The inter-gNB path switch may be used interchangeably with inter-CellGroup path switch or inter-SpCell path switch. The intra-gNB path switch may be used interchangeably with intra-CellGroup path switch or intra-SpCell path switch.

In some embodiments, the ID of the fourth device 140 may be configured via the RRC reconfiguration message. For example, it is indicated by the ReconfigurationWithSync in the RRC reconfiguration message comprising the information on the path switch. In some embodiments, the ID of the fourth device 140 may be indicated by the third device 130. As another example, the ID of the fourth device 140 may be indicated by the third device 130 via a discovery message, PC5-RRC signaling or PC5-S signaling. In some embodiments, the ID of the second device 120 may be indicated by the second device 120. For example, the ID of the second device 120 may be indicated during a synchronization procedure (e.g. a DL synchronization procedure) to the second device 120 or via a RRC message.

The determination of the configuration of the first device 110 for the path switch may comprise at least one of the following: a starting of a timer, DL synchronization, a setting of MAC entity, or a setting of a sidelink MAC entity. It is to be understood that any other suitable procedures may also be comprised. This will be described below in details.

### 1. Starting of Timer

In some embodiments, the first device 110 may start 210 a timer configured for the path switch. For example, the first device 110 may start the timer based on the configuration of the timer comprised in the information on the path switch. The timer may be a timer except T304.

In some embodiments, two timers may be configured, i.e., a timer (for convenience, also referred to as a first timer herein) for an intra-gNB path switch (also referred to as an intra cell group or intra SpCell path switch) and another timer (for convenience, also referred to as a second timer herein) for an inter-gNB path switch (also referred to as an inter cell group or inter SpCell path switch herein). In these embodiments, if the ID of the fourth device 140 is the ID of the second device 120, i.e., a target SpCell is not changed, the first device 110 may determine the path switch is the intra-gNB path switch. In this case, the first device 110 may start the first timer configured for the intra-gNB path switch. If the ID of the fourth device 140 is not the ID of the second device 120, i.e., a target SpCell is changed, the first device 110 may determine the path switch is the inter-gNB path switch. In this case, the first device 110 may start the second timer configured for the inter-gNB path switch. In this way, separate timers are configured for the inter-gNB and intra-gNB path switches. It is to be understood that the first and second timers may be configured with the same value or different values.

In some embodiments, the first timer may be configured with a set of first values for an intra-gNB path switch, and the second timer may be configured with a set of second values for an inter-gNB path switch. In these embodiments, an index may be configured to indicate one of the set of first or second values. For example, an example of configuration of timer values is shown in Table 1. In some embodiments, if the ID of the fourth device 140 is the ID of the second device 120, i.e. the intra-gNB path switch, the first device 110 may determine a first value (for example, 15 ms) from the configured set of first values based on the configured index (for example, index=3) and start the first timer with the first value. If the ID of the fourth device 140 is not the ID of the second device 120, i.e. the inter-gNB path switch, the first device 110 may determine a second value (for example, 25 ms) from the configured set of second values based on the configured index (for example, index=3) and start the second timer with the second value.

TABLE 1
An Example of Configuration of Timer Values

| Index | 1 | 2 | 3 |
|---|---|---|---|
| Inter-gNB | 15 ms | 20 ms | 25 ms |
| Intra-gNB | 5 ms | 10 ms | 15 ms |

In some embodiments, a timer value and an offset value may be configured. In these embodiments, if the ID of the fourth device 140 is the ID of the second device 120, the first device 110 may determine a first value of the first timer based on the configured timer value and start the first timer with the first value. If the ID of the fourth device 140 is not the ID of the second device 120, the first device 110 may determine a second value of the second timer based on the configured timer value and the configured offset value and start the second timer with the second value.

In some embodiments, a single timer may be configured for the first device 110. In these embodiments, the single timer may be configured with a first value and a second value different from the first value. The first value may be used for the intra-gNB path switch and the second value may be used for the inter-gNB path switch. For example, if the ID of the fourth device 140 is the ID of the second device 120, the first device 110 may start the single timer with the first value. If the ID of the fourth device 140 is not the ID of the second device 120, the first device 110 may start the single timer with the second value.

In this way, a timer is introduced for a path switch to relay UE.

### 2. DL Synchronization

Continue to with reference to FIG. 2, the first device 110 may determine 220 whether an ID of the fourth device 140 is an ID of the second device 120. In some embodiments, the first device 110 may determine the ID of the fourth device 140 from the information on the path switch comprised in the RRC reconfiguration message. In some embodiments, the first device 110 may determine the ID of the fourth device 140 from PC5 communication with the third device 130. The present disclosure does not limit this aspect. This determination 220 may be performed in similar way as that previously stated and thus other details are not repeated here for concise.

If the ID of the fourth device 140 is not the ID of the second device 120, the first device 110 may perform 221 DL synchronization. That is, if the RRC Reconfiguration message comprises the information on the path switch and if the identity of the fourth device 140 is not the identity of the second device 120, the first device 110 may perform the DL synchronization. In some alternatively embodiments, if the RRC Reconfiguration message comprises the information on the path switch and the information on the path switch indicates that the path switch is an inter-gNB path switch, the first device 110 may perform the DL synchronization.

In some embodiments, the first device 110 may start synchronization to a DL of the fourth device 140. In some embodiments, the first device 110 may apply a specified broadcast control channel (BCCH) configuration for the fourth device 140. In some embodiments, the first device 110 may acquire a master information block (MIB) of the fourth device 140.

In some embodiments, if the ID of the fourth device 140 is the ID of the second device 120, the first device 110 may omit reading the MIB of the fourth device 140. In some alternatively embodiments, if the RRC Reconfiguration message comprises the information on the path switch and the information on the path switch indicates that the path switch is an intra-gNB path switch, the first device 110 may omit reading the MIB of the fourth device 140.

In some alternative embodiments, if the RRC Reconfiguration message comprises the information on the path switch, the first device 110 may determine whether required timing information is obtained. If the required timing information is obtained, the first device 110 may omit reading the MIB of the fourth device 140.

In some alternative embodiments, if the RRC Reconfiguration message comprises the information on the path switch, the first device 110 may determine whether timing information is not required for random access. If the timing information is not required, the first device 110 may omit reading the MIB of the fourth device 140.

In some alternative embodiments, if the RRC Reconfiguration message comprises the information on the path switch, the first device 110 may determine whether required MIB or some information element (IE) of MIB for the fourth device 140 is obtained. If the required MIB or some IE of MIB is obtained, the first device 110 may omit reading the MIB of the fourth device 140.

In some alternative embodiments, if the RRC Reconfiguration message comprises the information on the path switch, the first device 110 may determine whether the third device 130 is configured for the first device 110 as relay UE. If the third device 130 is configured, the first device 110 may omit reading the MIB of the fourth device 140.

In this way, DL synchronization may be performed for a path switch to relay UE.

### 3. Setting of MAC Entity

Continue to with reference to FIG. 2, if the ID of the fourth device 140 is not the ID of the second device 120, the first device 110 may reset 230 a MAC entity of a cell group associated with the fourth device 140. That is, if the 201 RRC Reconfiguration message indicates information for path switch and if the identity of the fourth device 140 is not the identity of the second device 120, reset the MAC entity of the cell group associated with the fourth device 140. In some alternatively embodiments, if the RRC Reconfiguration message comprises the information on the path switch and the information on the path switch indicates that the path switch is an inter-gNB path switch, the first device 110 may reset the MAC entity of the cell group associated with the fourth device 140.

In some embodiments, the first device 110 may apply the value of the newUE-Identity as a cell-radio network temporary identifier (C-RNTI) for this cell group. In some embodiments, the first device 110 may consider the SCell(s) of this cell group, if configured, that are not included in the SCellToAddModList in the RRCReconfiguration message, to be in deactivated state. In some embodiments, the first device 110 may configure lower layers in accordance with the received spCellConfigCommon. In some embodiments, the first device 110 may configure lower layers in accordance with any additional fields, not covered in the previous, if included in the received reconfigurationWithSync.

If the ID of the fourth device 140 is the ID of the second device 120, the first device 110 may reuse 231 the MAC entity of the cell group associated with the fourth device 140. That is, if the RRC Reconfiguration message comprises the information on the path switch and if the ID of the fourth device 140 is the ID of the second device 120, the first device 110 may reuse the MAC entity of the cell group associated with the fourth device 140. In some alternatively embodiments, if the RRC Reconfiguration message comprises the information on the path switch and the information on the path switch indicates that the path switch is an intra-gNB path switch, the first device 110 may reuse the MAC entity of the cell group associated with the fourth device 140.

In some embodiments, the first device 110 may reuse the C-RNTI for this cell group. In some embodiments, the first device 110 may consider the SCell(s) of this cell group to be in activated state. In some embodiments, the first device 110 may consider the SCell(s) of this cell group, if configured, that are not included in the SCellToAddModList in the RRCReconfiguration message, to be in deactivated state.

In this way, MAC entity may be configured for a path switch to relay UE.

### 4. Setting of Sidelink MAC Entity

Continue to with reference to FIG. 2, the first device 110 may determine 240 whether the path switch is an indirect to indirect path switch from a source device (for example, the further third device 131) to the third device 130. If the path switch is the indirect to indirect path switch, the first device 110 may determine 241 whether an ID of the third device 130 is an ID of the source device. If the ID of the third device 130 is not the ID of the source device, the first device 110 may reset 242 a sidelink specific MAC entity of the first device 110. In some alternative embodiments, if the path switch is the indirect to indirect path switch, the first device 110 may reset a sidelink specific MAC entity of the first device 110. For example, the first device 110 may reset the sidelink specific MAC associated to the source device which is performed before the first device 110 establishing a PC5 connection (i.e., a sidelink connection) with the third device 130. As another example, the first device 110 may reset the sidelink specific MAC associated to the source device which is performed after the first device establishing a PC5 connection with the third device 130.

In this way, a sidelink MAC entity may be configured for a path switch to relay UE. So far, a configuration of the first device 110 for the path switch is determined, i.e., a reconfiguration of the first device 110 is done.

### 5. Stopping of Timer

With reference to FIG. 2, after the reconfiguration of the first device 110 is done, the first device 110 may transmit 204, by a sidelink adaptation layer or a RLC layer of the first device 110, a RRC reconfiguration complete message to the third device 130. That is, if the RRC Reconfiguration message comprises the information on the path switch, the upper layer (i.e. RRC layer) of the first device 110 may form the RRC reconfiguration complete message and indicate the lower layer (i.e. PDCP layer/sublayer) of the first device 110 to transmit it via PC5 connection to the third device 130.

The third device 130 may forward 205 the RRC reconfiguration complete message to the fourth device 140. The fourth device 140 may transmit 206, to the third device 130, an acknowledgement to the reception of the RRC reconfiguration complete message. In some embodiments, the acknowledgement may be a positive acknowledgement indicating a successful reception of the RRC reconfiguration complete message. In some embodiments, the acknowledgement may be a negative acknowledgement indicating an unsuccessful reception of the RRC reconfiguration complete message.

With reference to FIG. 2, the first device 110 may stop 207 the timer. In some embodiments, the first device 110 may determine 250 whether the RRC reconfiguration complete message is successfully transmitted. If the RRC reconfiguration complete message is successfully transmitted, the first device 110 may stop the timer. For example, if the lower layer (i.e. PHY layer) acknowledge for sending the RRC reconfiguration complete message is received from target relay (for example, the third device 130), the first device 110 may stop the timer.

In some embodiments, the first device 110 may determine 260 whether a PC5 unicast link (i.e., a sidelink connection) with the third device 130 is successfully established. If the PC5 unicast link with the third device 130 is successfully established, the first device 110 may stop the timer.

In some embodiments, the third device 130 may transmit 270 a RRC reconfiguration complete sidelink message to the first device 110. In response to receiving the RRC reconfiguration complete sidelink message, the first device 110 may stop the timer.

In some embodiments, the third device 130 may transmit 280, to the first device 110, an indication (for convenience, also referred to as a fourth indication herein) regarding the RRC reconfiguration complete message. In response to receiving the fourth indication, the first device 110 may stop the timer. In some embodiments, the fourth indication may indicate that the RRC reconfiguration complete message has been forwarded to the fourth device 140. In some embodiments, the fourth indication may indicate that the forwarding of the RRC reconfiguration complete message has been confirmed by the fourth device 140. In some embodiments, the fourth indication may indicate that the forwarding of the RRC reconfiguration complete message has not been confirmed by the fourth device 140.

So far, a path switch to relay UE may be done. In this way, a procedure for path switch to relay UE may be implemented with minimal modification to the specification.

### Example Implementation of Methods

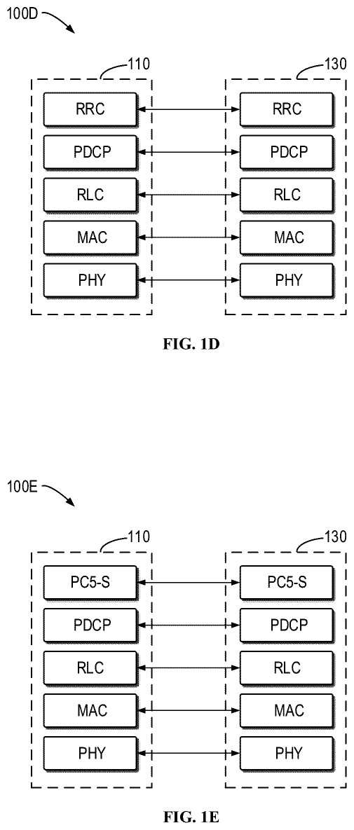

Accordingly, embodiments of the present disclosure provide methods of communication implemented at a terminal device and a network device. These methods will be described below with reference to FIGS. 3 to 5.

FIG. 3 illustrates an example method 300 of communication implemented at a first device as remote UE in accordance with some embodiments of the present disclosure. For example, the method 300 may be performed at the first device 110 as shown in FIG. 1. For the purpose of discussion, in the following, the method 300 will be described with reference FIG. 1. It is to be understood that the method 300 may include additional blocks not shown and/or may omit some blocks as shown, and the scope of the present disclosure is not limited in this regard.

At block 310, the first device 110 receives, from the second device 120, a RRC reconfiguration message.

At block 320, the first device 110 determines whether the RRC reconfiguration message comprises information on a path switch to the third device 130. The first device 110 is to be communicated with the fourth device 140 serving the third device 130 via the third device 130 and the first device 110 is to be communicated with the third device 130 via a sidelink interface.

In some embodiments, the information may comprise at least one of the following: an identity of the third device 130, an identity of the fourth device 140, a configuration of a timer for the path switch, a first indication indicating a direct to indirect path switch or an indirect to indirect path switch, a second indication indicating the direct to indirect path switch, or a third indication indicating the indirect to indirect path switch.

If the RRC reconfiguration message comprises the information, the process 300 proceeds to block 330. At block 330, the first device 110 determines a configuration of the first device 110 for the path switch based on a type of the path switch. In some embodiments, the first device 110 may determine the configuration of the first device 110 for the path switch at least based on an ID of the fourth device 140 and an ID of the second device 120. In this way, the type of the path switch may be determined in an implicit way. In some alternative embodiments, the first device 110 may determine the configuration of the first device 110 for the path switch based on an explicit indication of the type of the path switch (for example, an intra-gNB or inter-gNB path switch). In this way, the type of the path switch may be determined in an explicit way.

In some embodiments, the first device 110 may start a timer configured for the path switch. In some embodiments, the timer may comprise a first timer and a second timer. In these embodiments, the first device 110 may determine whether an ID of the fourth device 140 is an ID of the second device 120. If the ID of the fourth device 140 is the ID of the second device 120, the first device 110 may start the first timer. If the ID of the fourth device 140 is not the ID of the second device 120, the first device 110 may start the second timer.

In some embodiments, the first timer may be configured with a set of first values, and the second timer may be configured with a set of second values. In these embodiments, an index may be configured to indicate one of the set of the first or second values. In some embodiments, if the ID of the fourth device 140 is the ID of the second device 120, the first device 110 may determine a first value of the first timer from the configured set of first values based on the configured index and start the first timer with the first value. If the ID of the fourth device 140 is not the ID of the second device 120, the first device 110 may determine a second value of the second timer from the configured set of second values based on the configured index and start the second timer with the second value.

In some embodiments, a timer value and an offset value may be configured. In these embodiments, if the ID of the fourth device 140 is the ID of the second device 120, the first device 110 may determine a first value of the first timer based on the configured timer value and start the first timer with the first value. If the ID of the fourth device 140 is not the ID of the second device 120, the first device 110 may determine a second value of the second timer based on the configured timer value and the configured offset value.

In some embodiments where a single timer is configured, the timer may be configured with a first value and a second value different from the first value. In these embodiments, if the ID of the fourth device 140 is the ID of the second device 120, the first device 110 may start the timer with the first value. If the ID of the fourth device 140 is not the ID of the second device 120, the first device 110 may start the timer with the second value.

In some embodiments, the first device 110 may determine whether an ID of the fourth device 140 is an ID of the second device 120. If the ID of the fourth device 140 is not an ID of the second device 120, the first device 110 may perform an operation comprising at least one of the following: starting synchronization to a DL of the fourth device 140; applying a specified BCCH configuration for the fourth device 140; or acquiring a MIB of the fourth device 140.

In some embodiments, the first device 110 may determine whether an ID of the fourth device 140 is an ID of the second device 120. If the ID of the fourth device 140 is not an ID of the second device 120, the first device 110 may reset a MAC entity of a cell group associated with the fourth device 140. If the ID of the fourth device 140 is an ID of the second device 120, the first device 110 may reuse the MAC entity of the cell group associated with the fourth device 140.

In some embodiments, the ID of the fourth device 140 may comprise at least one of the following: an ID of a cell group provided by the fourth device 140; or an ID of a SpCell provided by the fourth device 140. In some embodiments, the ID of the second device 120 may comprise at least one of the following: an ID of a cell group provided by the second device 120; or an ID of a SpCell provided by the second device 120.

In some embodiments, the first device 110 may determine whether the path switch is an indirect to indirect path switch from a source device to the third device 130. If the path switch is the indirect to indirect path switch, the first device 110 may determine whether an ID of the third device 130 is an ID of the source device. If the identity of the third device is not the identity of the source device, the first device 110 may reset a sidelink specific MAC entity of the first device 110.

In some embodiments, the first device 110 may transmit, by a sidelink adaptation layer or a RLC layer of the first device 110, a RRC reconfiguration complete message to the third device 130.

In some embodiments, the first device 110 may stop the timer in response to at least one of the following: successfully transmitting a RRC reconfiguration complete message; successfully establishing a PC5 unicast link (i.e., a sidelink connection) with the third device 130; receiving a RRC reconfiguration complete sidelink message from the third device 130; or receiving, from the third device 130, a fourth indication regarding the RRC reconfiguration complete message. In some embodiments, the fourth indication may indicate one of the following: the RRC reconfiguration complete message has been forwarded to the fourth device 140; the forwarding of the RRC reconfiguration complete message has been confirmed by the fourth device 140; or the forwarding of the RRC reconfiguration complete message has not been confirmed by the fourth device 140.

With the method of FIG. 3, a procedure for path switch to relay UE may be provided.

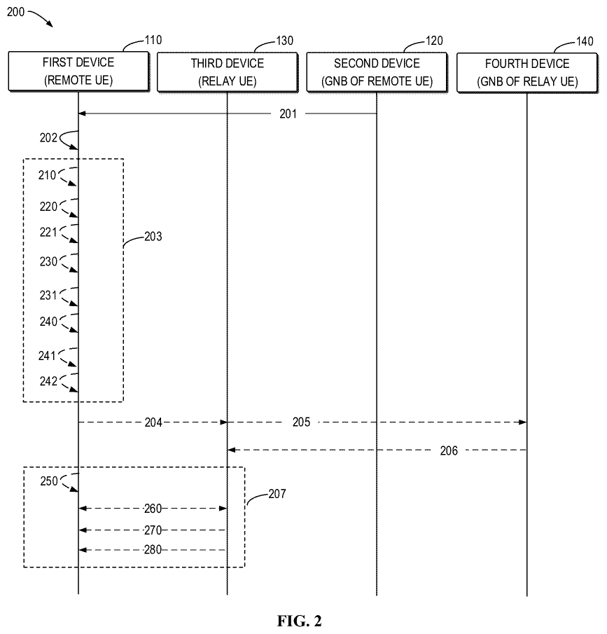

FIG. 4 illustrates an example method 400 of communication implemented at a second device as a network device serving remote UE in accordance with some embodiments of the present disclosure. For example, the method 400 may be performed at the second device 120 as shown in FIG. 1. For the purpose of discussion, in the following, the method 400 will be described with reference to FIG. 1. It is to be understood that the method 400 may include additional blocks not shown and/or may omit some blocks as shown, and the scope of the present disclosure is not limited in this regard.

At block 410, the second device 120 transmits, to the first device 110, a RRC reconfiguration message comprising information on a path switch to the third device 130. The first device 110 is to be communicated with the fourth device 140 serving the third device 130 via the third device 130 and the first device 110 is to be communicated with the third device 130 via a sidelink interface. For example, the second device 120 may cause the information on the path switch to be comprised in ReconfigurationWithSnyc of the RRC reconfiguration message.

In some embodiments, the information may comprise at least one of the following: an identity of the third device 130, an identity of the fourth device 140, a configuration of a timer for the path switch, a first indication indicating a direct to indirect path switch or an indirect to indirect path switch, a second indication indicating the direct to indirect path switch, or a third indication indicating the indirect to indirect path switch.

With the method of FIG. 4, a procedure for path switch to relay UE may be triggered.

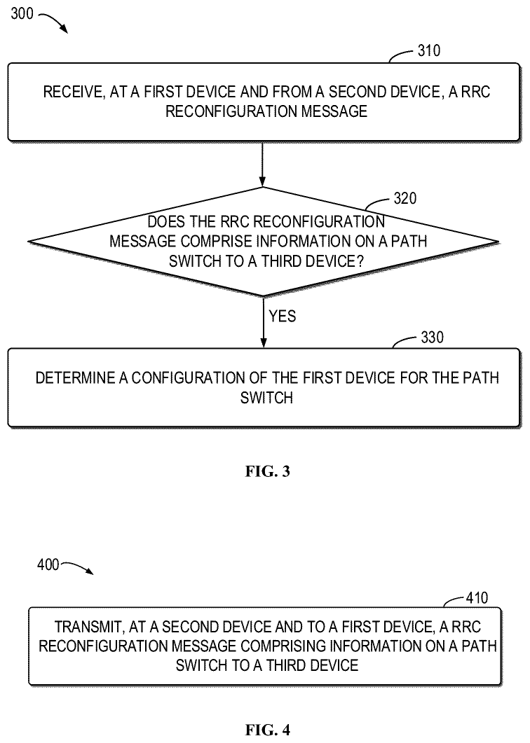

FIG. 5 illustrates an example method 500 of communication implemented at a third device as relay UE in accordance with some embodiments of the present disclosure. For example, the method 500 may be performed at the third device 130 as shown in FIG. 1. For the purpose of discussion, in the following, the method 500 will be described with reference to FIG. 1. It is to be understood that the method 500 may include additional blocks not shown and/or may omit some blocks as shown, and the scope of the present disclosure is not limited in this regard.

At block 510, the third device 130 receives a RRC reconfiguration complete message from the first device 110.

At block 520, the third device 130 forwards the RRC reconfiguration complete message to the fourth device 140. The first device 110 is to be communicated with the fourth device 140 serving the third device 130 via the third device 130 and the first device 110 is to be communicated with the third device 130 via a sidelink interface.

At block 530, the third device 130 transmits, to the first device 110, a fourth indication regarding the RRC reconfiguration complete message.

In some embodiments, the fourth indication may indicate one of the following: the RRC reconfiguration complete message has been forwarded to the fourth device 140; the forwarding of the RRC reconfiguration complete message has been confirmed by the fourth device 140; or the forwarding of the RRC reconfiguration complete message has not been confirmed by the fourth device 140.

With the method of FIG. 5, a procedure for path switch to relay UE may be provided.

### Example Implementation of Device and Apparatus

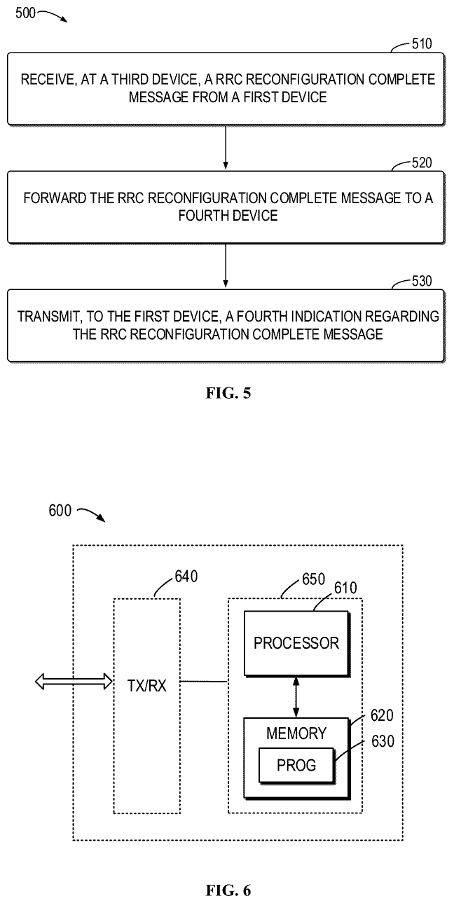

FIG. 6 is a simplified block diagram of a device 600 that is suitable for implementing embodiments of the present disclosure. The device 600 can be considered as a further example implementation of the first device 110 or the second device 120 or the third device 130 as shown in FIG. 1. Accordingly, the device 600 can be implemented at or as at least a part of the first device 110 or the second device 120 or the third device 130.

As shown, the device 600 includes a processor 610, a memory 620 coupled to the processor 610, a suitable transmitter (TX) and receiver (RX) 640 coupled to the processor 610, and a communication interface coupled to the TX/RX 640. The memory 610 stores at least a part of a program 630. The TX/RX 640 is for bidirectional communications. The TX/RX 640 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 630 is assumed to include program instructions that, when executed by the associated processor 610, enable the device 600 to operate in accordance with the embodiments of the present disclosure, as discussed herein with reference to FIGS. 1 to 5. The embodiments herein may be implemented by computer software executable by the processor 610 of the device 600, or by hardware, or by a combination of software and hardware. The processor 610 may be configured to implement various embodiments of the present disclosure. Furthermore, a combination of the processor 610 and memory 620 may form processing means 650 adapted to implement various embodiments of the present disclosure.

The memory 620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 620 is shown in the device 600, there may be several physically distinct memory modules in the device 600. The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

In some embodiments, a first device comprises circuitry configured to: receive, from a second device serving the first device, a RRC reconfiguration message; determine whether the RRC reconfiguration message comprises information on a path switch to a third device, wherein the first device is to be communicated with a fourth device serving the third device via the third device and the first device is to be communicated with the third device via a sidelink interface; and in accordance with a determination that the RRC reconfiguration message comprises the information, determining a configuration of the first device for the path switch.

In some embodiments, the information comprises at least one of the following: an identity of the third device, an identity of the fourth device, a configuration of a timer for the path switch, a first indication indicating a direct to indirect path switch or an indirect to indirect path switch, a second indication indicating the direct to indirect path switch, or a third indication indicating the indirect to indirect path switch.

In some embodiments, the circuitry may be configured to determine the configuration by starting a timer configured for the path switch.

In some embodiments, the timer comprises a first timer and a second timer. In these embodiments, the circuitry may be configured to start the timer by determining whether an identity of the fourth device is an identity of the second device; in accordance with a determination that the identity of the fourth device is the identity of the second device, starting the first timer; and in accordance with a determination that the identity of the fourth device is not the identity of the second device, starting the second timer.

In some embodiments, the circuitry may be configured to start the first timer by determining a first value of the first timer from a configured set of first values based on a configured index; and start the second timer by determining a second value of the second timer from a configured set of second values based on the configured index.

In some embodiments, the circuitry may be configured to start the first timer by determining a first value of the first timer based on a configured timer value, and start the second timer by determining a second value of the second timer based on the configured timer value and a configured offset value.

In some embodiments, the timer is configured with a first value and a second value different from the first value. In these embodiments, the circuitry may be configured to start the timer by determining whether an identity of the fourth device is an identity of the second device; in accordance with a determination that the identity of the fourth device is the identity of the second device, starting the timer with the first value; and in accordance with a determination that the identity of the fourth device is not the identity of the second device, starting the timer with the second value.

In some embodiments, the circuitry may be configured to determine the configuration by: determining whether an identity of the fourth device is an identity of the second device; and in accordance with a determination that the identity of the fourth device is not the identity of the second device, performing an operation comprising at least one of the following: starting synchronization to a DL of the fourth device; applying a specified BCCH configuration for the fourth device; or acquiring a MIB of the fourth device.

In some embodiments, the circuitry may be configured to determine the configuration by: determining whether an identity of the fourth device is an identity of the second device; in accordance with a determination that the identity of the fourth device is not the identity of the second device, resetting a MAC entity of a cell group associated with the fourth device; and in accordance with a determination that the identity of the fourth device is the identity of the second device, reusing the MAC entity of the cell group associated with the fourth device.

In some embodiments, the identity of the fourth device comprises at least one of the following: an identity of a cell group provided by the fourth device; or an identity of a special cell provided by the fourth device, and the identity of the second device comprises at least one of the following: an identity of a cell group provided by the second device; or an identity of a special cell provided by the second device.

In some embodiments, the circuitry may be configured to determine the configuration by: determining whether the path switch is an indirect to indirect path switch from a source device to the third device; in accordance with a determination that the path switch is the indirect to indirect path switch, determining whether an identity of the third device is an identity of the source device; and in accordance with a determination that the identity of the third device is not the identity of the source device, resetting a sidelink specific MAC entity of the first device.

In some embodiments, the circuitry may be further configured to transmit, by a sidelink adaptation layer or a radio link control layer of the first device, a RRC reconfiguration complete message to the third device.

In some embodiments, the circuitry may be further configured to stop the timer in response to at least one of the following: successfully transmitting a RRC reconfiguration complete message; successfully establishing a PC5 unicast link with the third device; receiving a RRC reconfiguration complete sidelink message from the third device; or receiving, from the third device, a fourth indication regarding the RRC reconfiguration complete message.

In some embodiments, the fourth indication indicating one of the following: the RRC reconfiguration complete message has been forwarded to the fourth device; the forwarding of the RRC reconfiguration complete message has been confirmed by the fourth device; or the forwarding of the RRC reconfiguration complete message has not been confirmed by the fourth device.

In some embodiments, a second device comprises a circuitry configured to: transmit, to a first device served by the second device, a RRC reconfiguration message comprising information on a path switch to a third device, wherein the first device is to be communicated with a fourth device serving the third device via the third device and the first device is to be communicated with the third device via a sidelink interface.

In some embodiments, the information comprises at least one of the following: an identity of the third device, an identity of the fourth device, a configuration of a timer for the path switch, a first indication indicating a direct to indirect path switch or an indirect to indirect path switch, a second indication indicating the direct to indirect path switch, or a third indication indicating the indirect to indirect path switch.

In some embodiments, a third device comprises a circuitry configured to: receive a RRC reconfiguration complete message from a first device; forward the RRC reconfiguration complete message to a fourth device, wherein the first device is to be communicated with the fourth device via the third device and the first device is to be communicated with the third device via a sidelink interface; and transmit, to the first device, a fourth indication regarding the RRC reconfiguration complete message.

In some embodiments, the fourth indication indicates one of the following: the RRC reconfiguration complete message has been forwarded to the fourth device; the forwarding of the RRC reconfiguration complete message has been confirmed by the fourth device; or the forwarding of the RRC reconfiguration complete message has not been confirmed by the fourth device.

In some embodiments, the first device and the third device are terminal devices, and the second device and the fourth device are network devices.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
receiving, at a first device and from a second device serving the first device, a radio resource control (RRC) reconfiguration message;
determining whether the RRC reconfiguration message comprises information on a path switch to a third device, wherein the first device is to be communicated with a fourth device serving the third device via the third device and the first device is to be communicated with the third device via a sidelink interface; and
in accordance with a determination that the RRC reconfiguration message comprises the information, determining a configuration of the first device for the path switch based on a type of the path switch.

2. The method of claim 1, wherein the information comprises at least one of the following:
an identity of the third device,
an identity of the fourth device,
a configuration of a timer for the path switch,
a first indication indicating a direct to indirect path switch or an indirect to indirect path switch,
a second indication indicating the direct to indirect path switch, or
a third indication indicating the indirect to indirect path switch.

3. The method of claim 1, wherein determining the configuration comprises:
starting a timer configured for the path switch.

4. The method of claim 3, wherein the timer comprises a first timer and a second timer, and wherein starting the timer comprises:
determining whether an identity of the fourth device is an identity of the second device;
in accordance with a determination that the identity of the fourth device is the identity of the second device, starting the first timer; and
in accordance with a determination that the identity of the fourth device is not the identity of the second device, starting the second timer.

5. The method of claim 4, wherein starting the first timer comprises determining a first value of the first timer from a configured set of first values based on a configured index; and
wherein starting the second timer comprises determining a second value of the second timer from a configured set of second values based on the configured index.

6. The method of claim 4, wherein starting the first timer comprises determining a first value of the first timer based on a configured timer value, and
wherein starting the second timer comprises determining a second value of the second timer based on the configured timer value and a configured offset value.

7. The method of claim 3, wherein the timer is configured with a first value and a second value different from the first value, and wherein starting the timer comprises:
determining whether an identity of the fourth device is an identity of the second device;
in accordance with a determination that the identity of the fourth device is the identity of the second device, starting the timer with the first value; and
in accordance with a determination that the identity of the fourth device is not the identity of the second device, starting the timer with the second value.

8. The method of claim 1, wherein determining the configuration comprises:
determining whether an identity of the fourth device is an identity of the second device; and
in accordance with a determination that the identity of the fourth device is not the identity of the second device, performing an operation comprising at least one of the following:
starting synchronization to a downlink (DL) of the fourth device;
applying a specified broadcast control channel (BCCH) configuration for the fourth device; or
acquiring a master information block (MIB) of the fourth device.

9. The method of claim 1, wherein determining the configuration comprises:
determining whether an identity of the fourth device is an identity of the second device;
in accordance with a determination that the identity of the fourth device is not the identity of the second device, resetting a medium access control (MAC) entity of a cell group associated with the fourth device; and
in accordance with a determination that the identity of the fourth device is the identity of the second device, reusing the MAC entity of the cell group associated with the fourth device.

10. The method of any of claims 4 and 7-9, wherein the identity of the fourth device comprises at least one of the following: an identity of a cell group provided by the fourth device; or an identity of a special cell provided by the fourth device, and
wherein the identity of the second device comprises at least one of the following: an identity of a cell group provided by the second device; or an identity of a special cell provided by the second device.

11. The method of claim 1, wherein determining the configuration comprises:
determining whether the path switch is an indirect to indirect path switch from a source device to the third device;
in accordance with a determination that the path switch is the indirect to indirect path switch, determining whether an identity of the third device is an identity of the source device; and
in accordance with a determination that the identity of the third device is not the identity of the source device, resetting a sidelink specific medium access control (MAC) entity of the first device.

12. The method of claim 1, further comprising:
transmitting, by a sidelink adaptation layer or a radio link control layer of the first device, a RRC reconfiguration complete message to the third device.

13. The method of claim 3, further comprising:
stopping the timer in response to at least one of the following:
successfully transmitting a RRC reconfiguration complete message;
successfully establishing a PC5 unicast link with the third device;
receiving a RRC reconfiguration complete sidelink message from the third device; or
receiving, from the third device, a fourth indication regarding the RRC reconfiguration complete message.

14. The method of claim 13, wherein the fourth indication indicating one of the following:
the RRC reconfiguration complete message has been forwarded to the fourth device;
the forwarding of the RRC reconfiguration complete message has been confirmed by the fourth device; or
the forwarding of the RRC reconfiguration complete message has not been confirmed by the fourth device.

15. A method of communication, comprising:
transmitting, at a second device and to a first device served by the second device, a radio resource control (RRC) reconfiguration message comprising information on a path switch to a third device, wherein the first device is to be communicated with a fourth device serving the third device via the third device and the first device is to be communicated with the third device via a sidelink interface.

16. The method of claim 15, wherein the information comprises at least one of the following:
an identity of the third device,
an identity of the fourth device,
a configuration of a timer for the path switch,
a first indication indicating a direct to indirect path switch or an indirect to indirect path switch,
a second indication indicating the direct to indirect path switch, or
a third indication indicating the indirect to indirect path switch.

17. A method of communication, comprising:
receiving, at a third device, a radio resource control (RRC) reconfiguration complete message from a first device;
forwarding the RRC reconfiguration complete message to a fourth device, wherein the first device is to be communicated with the fourth device via the third device and the first device is to be communicated with the third device via a sidelink interface; and
transmitting, to the first device, a fourth indication regarding the RRC reconfiguration complete message.

18. The method of claim 17, wherein the fourth indication indicates one of the following:
the RRC reconfiguration complete message has been forwarded to the fourth device;
the forwarding of the RRC reconfiguration complete message has been confirmed by the fourth device; or
the forwarding of the RRC reconfiguration complete message has not been confirmed by the fourth device.

19. The method of any of claims 1, 15 and 17, wherein the first and third devices are terminal devices, and the second and fourth devices are network devices.

20. A device of communication, comprising:
a processor configured to perform the method according to any of claims 1 to 14 or any of claims 17-19.

21. A device of communication, comprising:
a processor configured to perform the method according to any of claims 15 to 16.
